(19) United States
(12) Patent Application Publication
(10) Pub. No.: US 2024/0364700 A1
(43) Pub. Date: Oct. 31, 2024

(54) Method and System for Securely Exchanging Cryptographic Challenge/Response Messages

(71) Applicant: 6Harmonics Inc., Nepean (CA)

(72) Inventor: Andrew Spurgeon, Sharon (CA)

(73) Assignee: 6Harmonics Inc., Nepean, ON (CA)

(21) Appl. No.: 18/648,461

(22) Filed: Apr. 28, 2024

Related U.S. Application Data
(60) Provisional application No. 63/499,025, filed on Apr. 28, 2023.

(51) Int. Cl. H04L 9/40; H04L 9/32

(52) U.S. Cl. CPC H04L 63/105; H04L 9/3247; H04L 63/0823

(57) ABSTRACT

A method for credentials recovery is disclosed where a cryptographically secured secret is provided to a first user. A first radio associated with the first user is provided, the first radio having stored therein data for use in verifying a response received originates form the first user. A response is transmitter to the first radio, the response to a challenge including data derived from information for responding to the challenge and the cryptographically secured secret. The cryptographically secured secret is verified by at least one of a trusted system and the first radio to determine one of a verified trusted response and a verified untrusted response. In response to a verified trusted response, access credentials are reset within the radio.

### FIELD OF THE INVENTION

The invention relates to device security and more particularly to secure device recovery.

### BACKGROUND

To secure computer-based systems, access credentials are relied upon. These access credentials are provided every time a user seeks to access or modify aspects of a system or an account within a system. Thus, a WiFi router typically has a key for accessing WiFi signals therethrough and an administrative password for modifying router parameters such as an SSID and the key. Without the password, router parameters cannot be changed, so a failsafe is installed in most routers whereby when an owner forgets the administrative password, they can reset the WiFi router to factory settings and reconfigure the device. For WiFi routers, security is maintained by physically securing the router against tampering, against being reset.

Some users inevitably lose login credentials. Thus, secure systems are typically provided with login credential recovery options such as resetting a system to factory settings, recovering a lost password, alternative access methods, resetting a lost password, etc. Of course, loss of a password prevents secure access to a system for performing credential recovery. Thus, a chicken and egg problem exists when a system is not conveniently physically accessible but needs credential recovery.

Traditional recovery mechanisms are often insecure. Password recovery links can be intercepted or spoofed. Factory reset options are only secure when device access is severely restricted. Initiating password recovery is often insecure in order to afford end-users with convenience. The problem of recovery is inherently a balancing act between convenience and security, with security losing out in most implementations. To effectively balance between convenience and security, high-security installations rely on physical security to protect electronic devices and to prevent recovery absent secured physical access. An example is secure servers within a locked server room that is accessible to only a handful of people. This solution provides security and is convenient because resetting of servers is possible, but it is highly inconvenient for distributed hardware architectures such as communications infrastructure. For infrastructure, restricting physical access is difficult because communications hardware is installed distributed over large geographic areas and often requires positioning that is difficult to secure-on a tower. Traditional non-physical reset approaches to credential recovery are vulnerable to relatively basic attacks.

Credential reset options include factory reset, password recovery via a second channel, password reset from a central authority, and password reset via a second channel. Any field installed device can be physically compromised, and a physical reset engaged with little observation and little chance of noticing the reset operation. Further, physical reset operations often clear device memories and require complete reconfiguration, even when used by authorized persons. Thus, even if detected, a physical reset results in the inconvenience of needing to completely reconfigure a device.

Password reset options typically rely on verifying a user's identity through simple and unchanging responses to questions such as mother's maiden name or billing address. Though these protect against complete strangers randomly resetting credentials, they do not protect against people specifically targeting someone's credentials. Since the answers do not change, it is possible to determine all the information needed and use it to reset credentials. Above and beyond this inherent weakness, the storing of this data makes the system no more secure than security of the data storage. With recent hacks into all types of secure data, an organisation would be hard pressed to bet its existence on the security of third-party data storage.

It would be advantageous to provide a better means of credential reset or recovery.

### SUMMARY OF EMBODIMENTS

In accordance with embodiments of the invention there is provided a method comprising: providing a cryptographically secured secret to a first user; providing a first radio associated with the first user and having stored therein data for use in verifying an origin of a response received to a challenge; transmitting to the first radio a response to the challenge with data derived from information for responding to the challenge and the cryptographically secured secret; verifying the cryptographically secured secret by at least one of a trusted system and the first radio to determine one of a verified trusted response from an authorised origin and a verified untrusted response; in response, to a verified trusted response, resetting access credentials to the first radio; and in response to an untrusted response other than resetting access credentials to the first radio.

In accordance with another embodiment, there is provided a method comprising: providing a first radio associated with the first user and having stored therein data for use in verifying an origin of a response received to a challenge; providing from the first radio a challenge; transmitting to the first radio a response to the challenge with data derived from information for responding to the challenge and a cryptographically secured secret; verifying the cryptographically secured secret by the first radio to determine one of a verified trusted response from an authorised origin and an untrusted response; in response, to a verified trusted response, resetting access credentials to the first radio; and in response to an untrusted response other than resetting access credentials to the first radio.

In accordance with an embodiment there is provided a method comprising: providing a first radio associated with the first user and having stored therein data for use in verifying an origin of a response received to a challenge; transmitting to the first radio a certificate for use by the first radio to verify that a trusted source has verified a response to the challenge as from the first user; verifying the certificate by the first radio to determine one of a verified trusted response from an authorised origin and a verified untrusted response; in response, to a verified trusted response, resetting access credentials to the first radio; and in response to an untrusted response other than resetting access credentials to the first radio.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified flow diagram of a process leveraging standard network discovery protocols to securely exchange cryptographic challenge/response messages for supporting a simple method of credential recovery or for resetting lost device credentials over a network is shown;

FIG. 2 is a simplified flow diagram of a process wherein a specific radio transmits a challenge requesting a predetermined pattern of characters in response;

FIG. 3 is a simplified flow diagram of a process wherein a specific radio transmits a challenge requesting a time-varying pattern of characters in response;

FIG. 4 is a simplified flow diagram of a process wherein a specific radio transmits a challenge and an operator/owner of the specific radio responds to the challenge with a response that can be verified by the specific radio as both correct and having been provided from the operator;

FIG. 5 is a simplified flow diagram of a method of provisioning a specific radio wherein cryptographic data is stored within the specific radio during manufacture thereof for identifying an owner of the specific radio;

FIG. 6, is a simplified flow diagram of a method of automating credential recovery;

FIG. 7 is a simplified flow diagram of a process according to an embodiment from radio manufacture to credential recovery; and

FIG. 8 is a simple challenge architecture including a radio identifier, a public key identifier, a challenge, and an expiry time.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Cryptographic refers to a mathematical process of protecting data relying on a transform that is based on a secret. Some forms of cryptography, for example hashes, are destructive and irreversible. Other forms of cryptography allow for reconstituting obfuscated data using the secret. In public-private key cryptography, one key is public, publicly knowable, and another is private, secret, such that the public key can be shared with the public without violating security of the public-private key cryptography.

Password Recovery refers to a process by which a password is recovered or reset to a new password value. Typical password recovery mechanisms make use of information about a user for providing a user with access to a process for resetting a password by the user.

Certificate, Certify, Certification In computer security, a certificate is a digital document containing data and issued by an authority. For example, a public key certificate is issued by a certificate authority to certify that a given public key relates to a given user. Certificates are typically verifiable digital files or documents that allow anyone to verify that a certificate authority has certified contents of the file or document.

Digitally Sign or Digital Signature refers to a data obfuscation process that is known and when it is performed with a user's secret private key is proof that the file was obfuscated by the user. Because the process is known, it is possible to verify a digital signature with access to details of the known process and to the public key of the user.

PKI is an abbreviation for public key-private key infrastructure relating to a system wherein a private key—a secret—is used to do things only that party should be able to do—read its messages and digitally sign, for example—and a public key is used for securing messages for being read using the private key and for verifying digital signatures signed with the private key. Often, the private key is made up of parts of the public key such that the public key is determinable from the private key, but the private key is very difficult to determine from the public key without an unbelievable amount of luck or a very long time interval on the order of many years.

Private Key is a secret of a first user that is used in symmetric or asymmetric encryption to obfuscate data or to extract plain text data—data that is unencrypted—from obfuscated data. In symmetric encryption the same secret is used to encrypt and decrypt. In asymmetric encryption, a private key is used to access secret data while a public key is used to obfuscate same, so that anyone can encrypt data for the first user, but only the first user can decrypt said data. When used as a digital signature, the private key is used to sign and the public key is used to verify a signature.

Public Key is a non-secret relating to a first user that is used in asymmetric encryption. In asymmetric encryption, a private key is used to access secret data while a public key is used to obfuscate same, so that anyone can encrypt data for the first user, but only the first user can decrypt said data. A public key is also used for verifying digitally signed or cryptographically signed data. Though a public key is described as “public” this merely refers to the key not needing to be kept secret-knowing the public key does not compromise security. That said, some public keys are still not publicly disclosed.

Challenge-Response is a form of security wherein a challenge is issued from a first system and a response to the challenge is verifiable as both being from an authorised second system and being responsive to the challenge. For example, a challenge could simply be a phrase that needs to be digitally signed by the authorised second system to verify that the authorised second system has access to a private key of the authorised second system.

Today's most commonly used credential recovery involves calling into a service provider. The service provider then challenges the caller to prove their identity through a series of challenge-response pairs. Once the service provider believes the caller to be authentically who they claim to be, the service provider sends an email to an email address associated with an account of whom the service provider believes the caller to be. The email includes a link and engaging the link provides a password reset. A malicious individual could collect a user's information and then when they have access to the user's email, the malicious individual could call the service provider, authenticate through a challenge response process, and intercept the link, when sent, to reset the password.

In its simplest form, challenge-response authentication is composed of two basic components: a question and a response. The goal of the question, or challenge, is to require a response that only authorized users will know. Users that successfully answer the question are allowed access to whatever digital materials the challenge-response authentication mechanism (CRAM) is safeguarding. Though this is a simple premise, the tools, knowledge and information required to pass these challenges can become quite complex.

There are two basic architectures for challenge response. In a first, a user is challenged with questions that only they can answer. Problematically, such questions are rare and an answer to those questions once determined by a third party makes those questions permanently insecure. An example of challenge response is used every time you call the phone company. The person at the other end of the call, asks questions that are intended to verify that they are speaking with the account holder. However, questions like account holder name and address, or birthdate, may be common knowledge. Information from a statement, such as an account number, is easily acquired by stealing, photographing, copying or just reading a statement. Through methodical data gathering, most questions used in these verifications and their associated responses can be gathered.

The goal of challenge-response authentication is to limit the access, control and use of digital resources to only authorized users and activities. After all, users aren't the only ones sending requests. If a mobile application or a malicious software (malware) program requests access to a set of photos, it can be denied by integrating challenge-response authentication. Because challenges aren't just limited to questions and answers, they can involve more complicated tasks and code decryption.

At the other extreme of challenge response, are digital devices that are synchronised to provide a unique number during a brief period of time. The numbers are presented in an order that would be hard to predict without some knowledge of a secret that even the user need not know. Thus, without the device, providing the number would be nearly impossible. A user seeking access or calling in, when asked to provide the number, looks at the device and reads off the number or types the number to respond to the query. Though such a system is much more secure than simply asking personal questions, the inconvenience of carrying the device and using it is obvious.

Thus, it is commonly known that truly convenient security is typically less secure and truly secure processes are usually quite inconvenient.

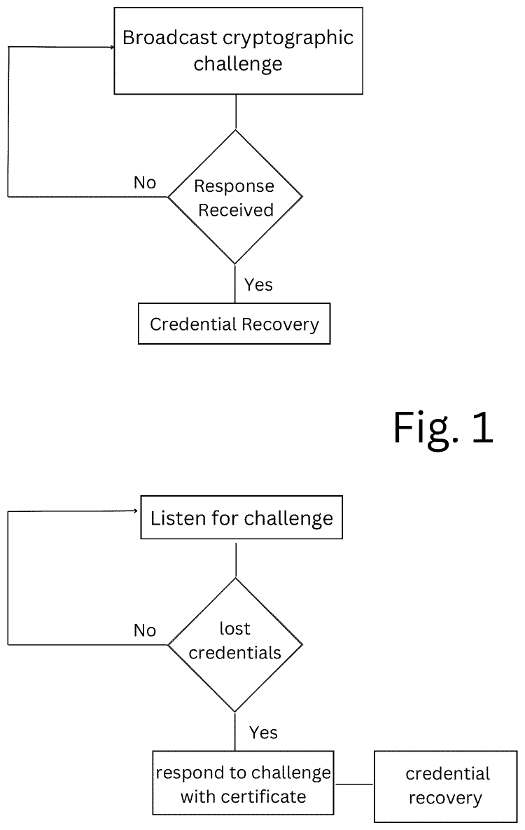

Referring to FIG. 1, a process leveraging standard network discovery protocols to securely exchange cryptographic challenge/response messages for supporting a simple method of credential recovery or for resetting lost device credentials over a network is shown.

A field installed device relies upon a network broadcast protocol for distributing a cryptographic challenge. The cryptographic challenge is for account recovery, though it is also usable for other applications. A new cryptographic challenge is distributed at intervals. Alternatively, a same challenge is used. Further alternatively, a cryptographic challenge is only transmitted when requested.

It has now been discovered that relying on a cryptographic challenge allows all transmitted challenge data to be “public” in nature such that no secret is shared. For example, a cryptographic challenge is signed to allow a recipient to verify from where the challenge was transmitted using a public key of the challenger. The challenge contents are public domain because a response to the challenge must be signed using a secret of a trusted authority-a certificate authority, an owner of the device, a trusted custodian, a manufacturer of the device, etc. In this way, a device is verifiable as is a trusted authority and an exchange allows for credential recovery.

When access credentials for a specific radio are lost by an operator, a network monitoring tool is used to listen on the network for packets of a cryptographic challenge that were/are broadcast by the specific radio, for example being broadcast at regular intervals. Once the cryptographic challenge is received by the monitoring tool, the operator transmits or causes to be transmitted to the specific radio a certificate containing the challenge token that has also been signed by the trusted authority thereby cryptographically proving ownership of the radio by the operator. The radio then allows the operator to connect and modify login credentials, typically via a secure communication path. For example, the radio transmits a signal to the operator to set up a secure path to the radio to allow for resetting of credentials.

Thus, the process involves a challenge having a known origin, a response to the challenge cryptographically verifiable that a respondent is authorised or owns a specific radio. In the above description, the challenge is cryptographic and the response is also cryptographic. Other embodiments are also supported.

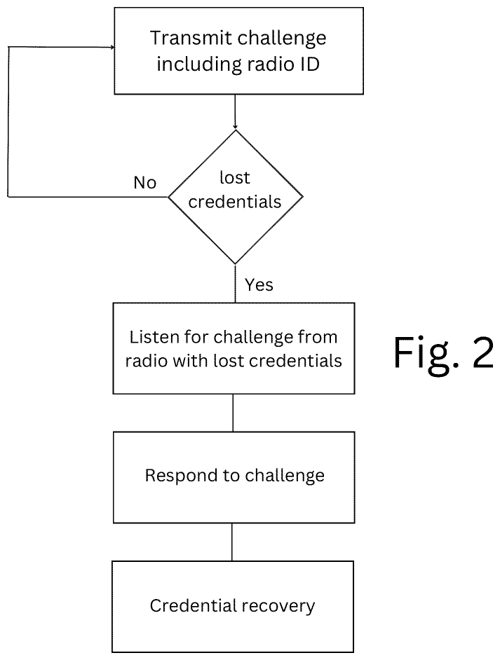

Referring to FIG. 2, shown is a simplified flow diagram of an embodiment. A specific radio transmits a challenge requesting a pattern of characters in response. An example pattern of characters is the following: {Radio number-month (XX)-day (XX)-“Hello”-hour (XX)}. A specific radio is encoded with an identifier for a key of its operator. The operator, in order to reset credentials, provides to the specific radio a response to a received challenge including the requested information signed with a private key of the operator. The specific radio verifies the signature and in response resets credentials for the operator. Thus, within limits of a selected encryption standard and key length, only the operator with its unique private key is able to cause a reset of access credentials.

When the operator is the trusted authority, the operator receives the challenge and responds to the challenge with a digitally signed response relying, for example, on the operator's secret, private key. By referring to and/or retrieving the operator's public key, the radio can verify both the response's contents and its origin—the operator.

Here, a private key of the operator is maintained secret. A public key of the operator is stored in each radio; alternatively, an indicator for retrieving a public key of the operator is stored in each radio. This data is stored during manufacture. Alternatively, it is stored during configuration. Thus, a radio is capable of verifying that each cryptographic message from an operator is authentically from the operator. If updating the private key of the radio and the owner is not permitted with physical access or normal login operations, then a radio is secure so long as the credential recovery mechanism remains secure.

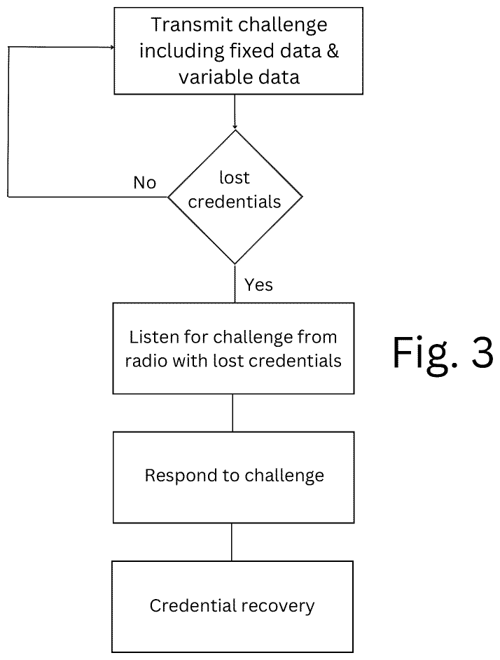

Referring to FIG. 3, shown is a simplified flow diagram. A specific radio transmits a challenge requesting a pattern of characters in response. For example, {Radio number-month (XX)-day (XX)-“Hello”-hour (XX)}.

A specific radio is encoded with an identifier for a key of its operator. The operator, in order to reset credentials, provides to a trusted certificate authority a cryptographic response to the received challenge including the requested information. The trusted certificate authority verifies the cryptographic response and when verified, provides a certificate to the specific radio for resulting in a reset of access credentials. The certificate is verifiable by the specific radio as being uniquely provided by the trusted certificate authority. Here again, cryptography is used to verify as between the parties, with whom each is communicating. This limits a series of attacks that would greatly reduce security or greatly increase inconvenience.

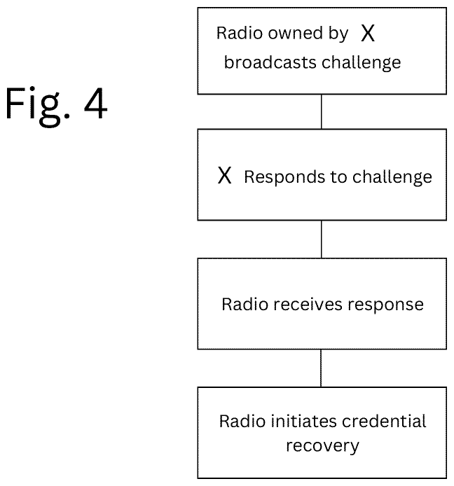

Referring to FIG. 4, a more generic form of a process is shown. Here, a specific radio transmits a challenge. An operator of the specific radio, typically an owner thereof, responds to the challenge with a response that can be verified by the specific radio as both correct and having been provided from the operator. This verification is either performed by the specific radio, by a trusted third party, or by both the radio and a trusted third party. Cryptography is used to ensure accurate identification of parties involved. In some embodiments, cryptographic identifiers are stored during manufacture of a specific radio. In some embodiments, cryptographic identifiers are stored during provisioning of a specific radio.

In an embodiment, the specific radio transmits the response to a trusted certificate authority for verification. In another embodiment, the specific radio decrypts the response and verifies its content and origin internally.

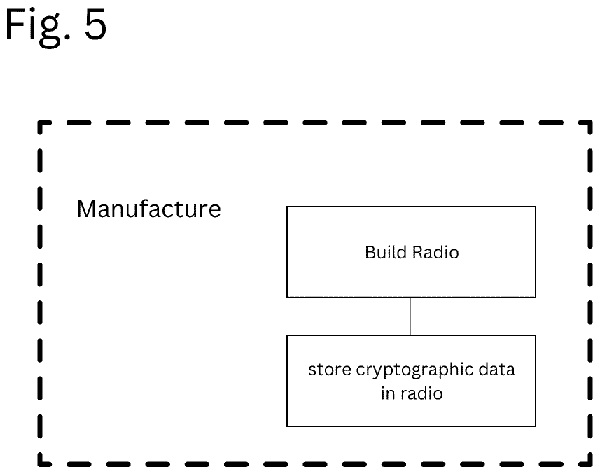

Referring to FIG. 5, shown is a method of provisioning a specific radio. The specific radio is manufactured with cryptographic data stored therein for identifying an owner thereof. During provisioning, an installer installs the specific radio and sets up passwords, etc. If the installer fails to provide the password to the owner or if the installer makes an error in providing the password to the owner, the owner relies on the cryptographic data to reset credentials according to a method described herein. Thus, some forms of installer error are less consequential and recovery from installer error will not require a repeat visit to the specific radio in some situations.

The process supports symmetric encryption keys, wherein the secret key is stored within the radios by the operator and known to the operator. The process also supports asymmetric key cryptography wherein the cryptographic public key of the operator is considered public information, even if stored within the radio in a secure fashion. When using asymmetric key cryptography, only the secret private key of an operator, the key only accessible to the operator, need be protected for securing a response.

A response to a cryptographic challenge is automatically generatable in some situations. For example, if the challenge involves responses from known or determinable data, then a system of the operator or of a trusted authority could automatically generate the response, for example in the above-described embodiment, the time and date are known. An operator could simply authenticate to their account and then approve a credential recovery operation for the specific radio. When challenges are fixed, then responding might be possible by listening to previous responses that are encoded. Thus, challenges are most secure when they change or when contents of each response are different. For example, challenges might simply be selected from a list wherein with each correct response—each credential recovery—the radio moves onto a next item in the list. Alternatively, as described above, challenges include requests for varying data such that no two responses should be identical. When a trusted third-party authority is relied upon, they need only verify that the operator wants to reset credentials for a specific radio and then they can automatically respond to the challenge in order to initiate credential recovery.

For example, credential recovery involves forming a secure channel for allowing an operator to reset credentials within the specific radio.

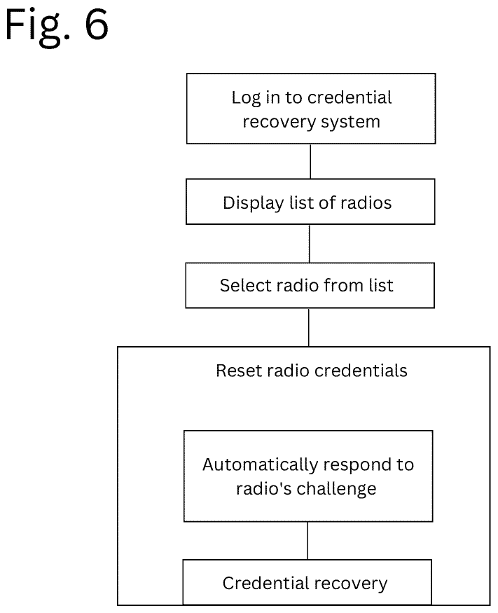

Referring to FIG. 6, shown is a simplified method of automating credential recovery. An operator logs into their credential recovery system. This system is a cryptographic system with access to data for verifying the operator. The system presents the operator with a list of radios that they own or control. The operator selects a radio and resets credentials for the radio. The automated credential recovery system then prepares a response to a challenge received from that radio and requests operator approval, for example requiring the operator to authenticate, in the form of re-entering their password for the automated credential recovery system, and then transmits the response to its destination. In response to the response being received, the selected radio resets its access credentials, for example to an access credential provided by the automated credential recovery system along with its response. The access credential is optionally provided in a secure fashion, for example encrypted with a public key of the radio. Alternatively, access credentials are reset to access credentials provided by a certificate provider and shared with the operator and the specific radio. Alternatively, the access credentials are reset to predetermined values.

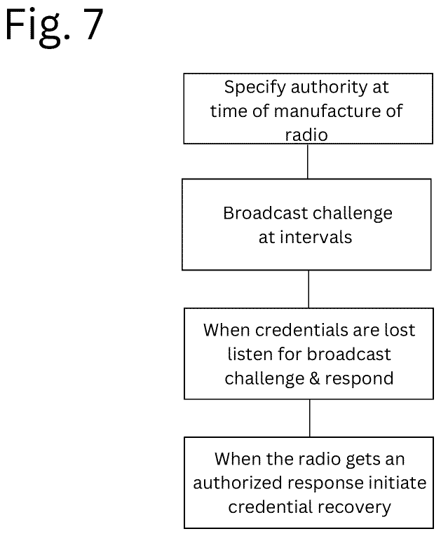

Referring to FIG. 7, shown is a simplified process from radio manufacture to credential recovery. By leveraging standards-based Public Key Infrastructure, PKI, a trusted authority is selected to be trusted by a first radio. For example, the authority is specified at time of manufacture (i.e. “Trusted Manufacturer”) or at time of deployment (i.e. “Trusted Operator”). Thus, instead of simply relying on physical access or on an employee to verify credentials, a trusted authority is needed to restore credentials.

In the event that access credentials for a specific radio are lost by an operator, a network monitoring tool is used to listen on the network for challenge packets, which are broadcast by the specific radio at regular intervals (e.g., every 300 seconds). In response, the operator provides to the radio a certificate that contains at least one of the challenge token and a challenge response and which has also been signed by the trusted authority, thereby cryptographically proving ownership of the radio. The specific radio then allows a user to connect and modify login credentials.

When implemented correctly, such an approach can be more secure than some previous approaches as it never exposes any cryptographically sensitive information from within devices—all data in flight is public knowledge or knowledge of it does not affect security. Additionally, it removes any advantage an attacker may gain by having physical access to the radio, potentially short of destruction of the chassis. For example, a physical reset button on a radio might reset some parameters, but when access credentials are only modifiable through a cryptographically secured recovery process, resetting the device does not provide access to parameters or data that is secured through access credentials. Potentially, the reset button initiates a reset operation including credential recovery according to an embodiment disclosed herein.

Broadcasting of challenges at intervals is optionally by way of LLDP protocol data inclusion of IP address and challenge data. Thus, periodic challenge data piggy backs on existing network protocols. Alternatively, challenge data is broadcast via another network protocol. Further alternatively, challenge data is broadcast via a communication layer. Yet further alternatively, challenge data is broadcast via the network as transmit data. In some embodiments, challenge data is merely transmitted addressed to a specific pre-programmed destination at regular intervals.

In some embodiments, radios do not broadcast challenges, but instead provide challenges only when requested to do so. This prevents simple discovery of radios, an owner would need to know their radios, and does not greatly improve security. That said, such a process is supported. In an embodiment, radios broadcast at first intervals until an operator confirms that the radio is known and data relating thereto is stored by the operator; then the radio ceases to broadcast information or only broadcasts information at long intervals, longer than the first intervals.

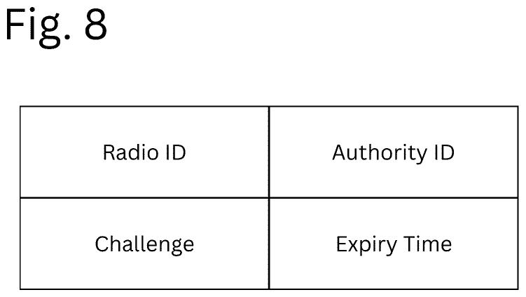

Referring to FIG. 8, shown is a simple challenge architecture. Here, a challenge includes a radio identifier, an authority ID in the form of a public key identifier, a challenge, and an expiry time. The public key identifier is for a public key of the authority to respond to the challenge—this is typically a public key associated with the secret private key of the intended responder-typically also identifies the radio's owner/operator. Challenges typically include signed data to allow a listener to verify that a challenge originates from a specific known radio. Such a challenge is easily identifiable by an operator because of the key data, allowing operators to “discover” their radios. Further, it is clear and purposeful and quite compact in terms of bandwidth utilisation. Finally, its origin is optionally cryptographically verifiable to limit efficacy of spoofing and/or man-in-middle attacks.

In yet another embodiment, the radio never broadcasts a challenge and instead is expecting a response to a known challenge and cryptographic data such that receiving a signal containing the anticipated response properly encoded, though no challenge is provided, allows for credential recovery. For example, a radio seeks a specific known response, whether fixed, synchronised, or variable, related to a specific known operator for that radio. Thus, for example, the use of a synchronised number generator within the radio and within the operator system allows for a verifiable unique response absent a challenge being broadcast. That said, as long as the challenge response is automatically generated by the operator systems, inconvenience is limited.

In some embodiments, each certificate has a valid before or after date for enhancing the security of the system. In such a system, certificates are regularly updated and a challenge response is performed with updated certificates. Updating of certificates has significant advantages in cryptography and when those advantages are sought, certificate expiration periods are set accordingly.

Advantageously, in some embodiments each radio transmits an identifier and an identifier of a trusted authority and owner. Thus, an owner can simply listen for all radio broadcasts wherein it is identified as an owner and can from that build a list of radios under its ownership. Often, this identifier is related to encryption keys-a public key is a form of identifier. In another embodiment, an owner responds to all broadcasts from unknown radios; only “acceptable” authorised responses allow for credential recovery. Thus, even if the dataset of radios is compromised, lost or deleted, an owner can reconstruct the dataset by listening to broadcasts and discovering which radios are under their ownership.

Numerous other embodiments may be envisaged without departing from the scope of the invention.

What is claimed is:

1. A method comprising:
providing a cryptographically secured secret to a first user;
providing a first radio associated with the first user and having stored therein data for use in verifying an origin of a response received to a challenge;
transmitting to the first radio a response to the challenge with data derived from information for responding to the challenge and the cryptographically secured secret;
verifying the cryptographically secured secret by at least one of a trusted system and the first radio to determine one of a verified trusted response from an authorised origin and a verified untrusted response;
in response, to a verified trusted response, resetting access credentials to the first radio; and
in response to an untrusted response other than resetting access credentials to the first radio.

2. A method according to claim 1 wherein, the verified trusted response includes new access credentials.

3. A method according to claim 1 wherein, resetting access credentials comprises resetting access credentials to a default value.

4. A method according to claim 1 wherein, resetting access credentials comprises resetting access credentials through a further secure data exchange.

5. A method according to claim 1 comprising: providing from the first radio the challenge.

6. A method according to claim 5 wherein providing from the first radio the challenge comprises broadcasting from the first radio a challenge packet at intervals, the challenge packet comprising challenge data.

7. A method according to claim 6 wherein the challenge data is verifiably provided by the first radio.

8. A method according to claim 6 wherein the challenge data is cryptographically verifiable as being provided by the first radio.

9. A method according to claim 6 wherein the challenge data comprises a radio identifier for identifying the first radio.

10. A method according to claim 1 wherein verifying the cryptographically secured secret by at least one of a trusted system and the first radio to determine one of a verified trusted response from an authorised origin and a verified untrusted response comprises verifying the first user in reliance upon a trusted authority.

11. A method according to claim 10 wherein verifying the cryptographically secured secret by at least one of a trusted system and the first radio to determine one of a verified trusted response from an authorised origin and a verified untrusted response comprises receiving a certificate of a response from the first user, the certificate provided by the trusted authority.

12. A method according to claim 10 wherein verifying the cryptographically secured secret by at least one of a trusted system and the first radio to determine one of a verified trusted response from an authorised origin and a verified untrusted response comprises receiving a certificate of a trusted authority, the trusted authority having verified a response by the first user.

13. A method according to claim 1 wherein verifying the cryptographically secured secret by at least one of a trusted system and the first radio to determine one of a verified trusted response from an authorised origin and a verified untrusted response comprises verifying a cryptographic signature of the first user by the first radio.

14. A method comprising:
providing a first radio associated with the first user and having stored therein data for use in verifying an origin of a response received to a challenge;
providing from the first radio a challenge;
transmitting to the first radio a response to the challenge with data derived from information for responding to the challenge and a cryptographically secured secret;
verifying the cryptographically secured secret by the first radio to determine one of a verified trusted response from an authorised origin and an untrusted response;
in response, to a verified trusted response, resetting access credentials to the first radio; and
in response to an untrusted response other than resetting access credentials to the first radio.

15. A method according to claim 14 wherein, the verified trusted response includes new access credentials.

16. A method according to claim 14 wherein, resetting access credentials comprises resetting access credentials to a default value.

17. A method according to claim 14 wherein, resetting access credentials comprises resetting access credentials through a further secure data exchange.

18. A method according to claim 14 wherein providing from the first radio a challenge comprises broadcasting from the first radio a challenge packet at intervals, the challenge packet comprising challenge data.

19. A method according to claim 18 wherein the challenge data is verifiably provided by the first radio.

20. A method according to claim 18 wherein the challenge data is cryptographically verifiable as being provided by the first radio.

21. A method according to claim 18 wherein the challenge data comprises a radio identifier for identifying the first radio.

22. A method comprising:
providing a first radio associated with the first user and having stored therein data for use in verifying an origin of a response received to a challenge;
transmitting to the first radio a certificate for use by the first radio to verify that a trusted source has verified a response to the challenge as from the first user;
verifying the certificate by the first radio to determine one of a verified trusted response from an authorised origin and a verified untrusted response;
in response, to a verified trusted response, resetting access credentials to the first radio; and
in response to an untrusted response other than resetting access credentials to the first radio.
